(19) United States
(12) Patent Application Publication
(10) Pub. No.: US 2025/0245555 A1
(43) Pub. Date: Jul. 31, 2025

(54) INTELLIGENT MAP DATA MANAGEMENT AND EVICTION FOR AUTONOMOUS SYSTEMS AND APPLICATIONS

(71) Applicant: NVIDIA CORPORATION, Santa Clara, CA (US)

(72) Inventors: Michael Stanton KRON, Redmond, WA (US); Jeffrey Chun-Hin LIU, Bellevue, WA (US); Russell Roy CHREPTYK, Seattle, WA (US)

(21) Appl. No.: 18/427,288

(22) Filed: Jan. 30, 2024

(51) Int. Cl. G06N 20/00

(52) U.S. Cl. CPC G06N 20/00

(57) ABSTRACT

In various examples, a technique for managing map data stored in a location-aware system includes determining a corresponding set of attributes for each of a plurality of map data units stored in a memory within the location-aware system. For each map data unit included in the plurality of map data units, the technique computes a priority score for the map data unit based on the set of attributes corresponding to the map data unit. The technique also includes determining, based on the plurality of priority scores for the plurality of map data units, one or more map data units to be evicted from the memory. The technique further includes causing at least a portion of the one or more map data units to be deleted from the memory in response to receiving one or more new map data units for storage in the memory.

### BACKGROUND

Autonomous vehicles, semi-autonomous vehicles, and/or other types of modern vehicles are typically equipped with navigation systems that use geographically indexed map data to provide geolocation, navigation, planning, and/or other types of location-based services to the users. This map data may be organized into layers representing different types of data, such as (but not limited to) images, roads, interstates, road surface markings, traffic signs, radar points, traffic conditions, weather conditions, landmarks, topography, and/or metadata. This map data may additionally be divided along spatial boundaries into discrete units, such as map tiles representing contiguous geographic regions within a map. These discrete units may further be defined at multiple “zoom” levels representing different levels of detail. For example, a map tile associated with a low zoom level may represent a relatively large area such as a city, while a map tile associated with a high zoom level may represent a single building or city block.

During operation of a vehicle, discrete units of map data are typically downloaded by the vehicle from a server and stored in non-volatile flash memory on a system-on-chip (SoC). As the vehicle drives to new geographic areas, additional map data units (e.g., tiles) for the new geographic areas are downloaded and stored in the SoC so that the vehicle can continue to provide navigation services. Because the memory on the SoC has limited storage capacity, at least some of the existing map data stored on the SoC generally has to be evicted to make room for the newly downloaded map data.

Conventional approaches for updating map data used in vehicular navigation typically involve replacing the first available unused map tiles on disk and/or in a directory tree with new map data. These conventional approaches may also, or instead, employ a Least Recently Used (LRU) technique to replace map data that has not been used for the longest time with newly downloaded map data. However, the naïve and rudimentary nature of these conventional approaches may cause existing map data that is likely to be needed in the near future to be deleted, thereby incurring additional resource overhead and potential latency when the deleted map data is subsequently redownloaded.

As such, a need exists for more effective techniques for improving cache and memory management of map data used in vehicular navigation.

### SUMMARY

Embodiments of the present disclosure relate to intelligent map data management and eviction. The techniques described herein include determining a corresponding set of attributes for each of a plurality of map data units stored in a memory within the location-aware system. The techniques also include for each map data unit included in the plurality of map data units, computing a priority score for the map data unit based on the set of attributes corresponding to the map data unit. The techniques further include determining, based on the plurality of priority scores for the plurality of map data units, one or more map data units to be evicted from the memory and causing at least a portion of the one or more map data units to be deleted from the memory in response to receiving one or more new map data units for storage in the memory.

One technical advantage of the disclosed techniques relative to prior approaches is the ability to efficiently use limited memory to store and update map data on a location-aware system. In this regard, the techniques prioritize map data units for eviction based on various attributes that are relevant to subsequent use of the map data units and/or costs associated with downloading the map data units, thereby reducing the likelihood that evicted map data will subsequently need to be redownloaded. Consequently, the disclosed techniques improve data reuse, network utilization, and resource overhead when compared with conventional, naïve approaches for managing and updating stored map data.

### BRIEF DESCRIPTION OF THE DRAWINGS

The present systems and methods for intelligent map data management and eviction are described in detail below with reference to the attached drawing figures, wherein:

FIG. 1 illustrates a computing device configured to implement one or more aspects of various embodiments;

FIG. 2 is a more detailed illustration of the management engine and processing engine of FIG. 1, according to various embodiments;

FIG. 3A illustrates the example operation of the management engine of FIG. 1 in determining a set of eviction candidates, according to various embodiments;

FIG. 3B illustrates the example operation of the management engine of FIG. 1 in determining a set of eviction candidates, according to various embodiments;

FIG. 4A illustrates a flow diagram of a method for managing map data stored in a location-aware system, according to various embodiments;

FIG. 4B illustrates a flow diagram of a method for generating priority scores for map data units using a machine learning model, according to various embodiments;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

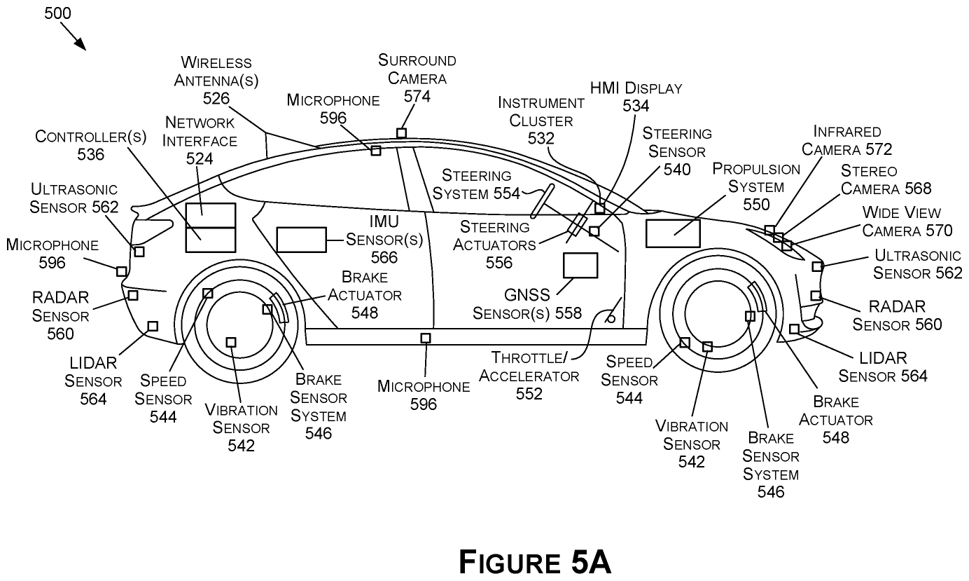

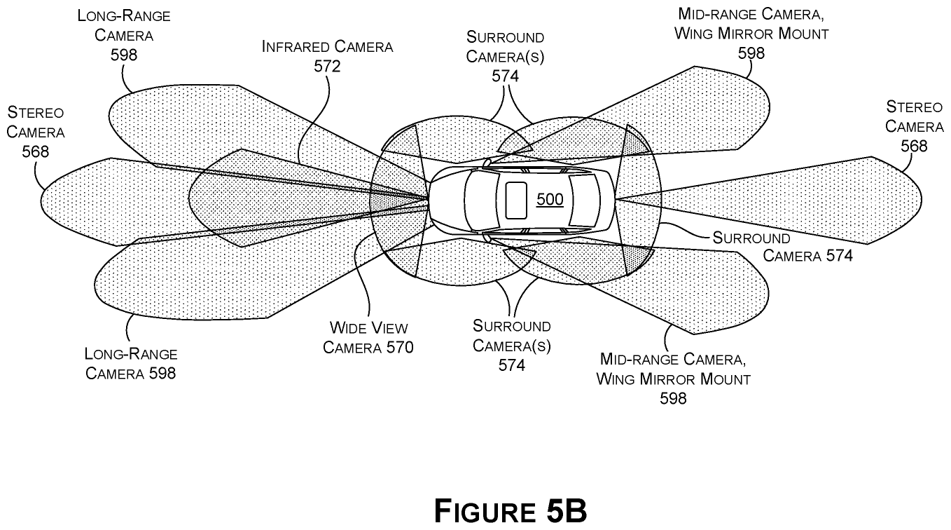

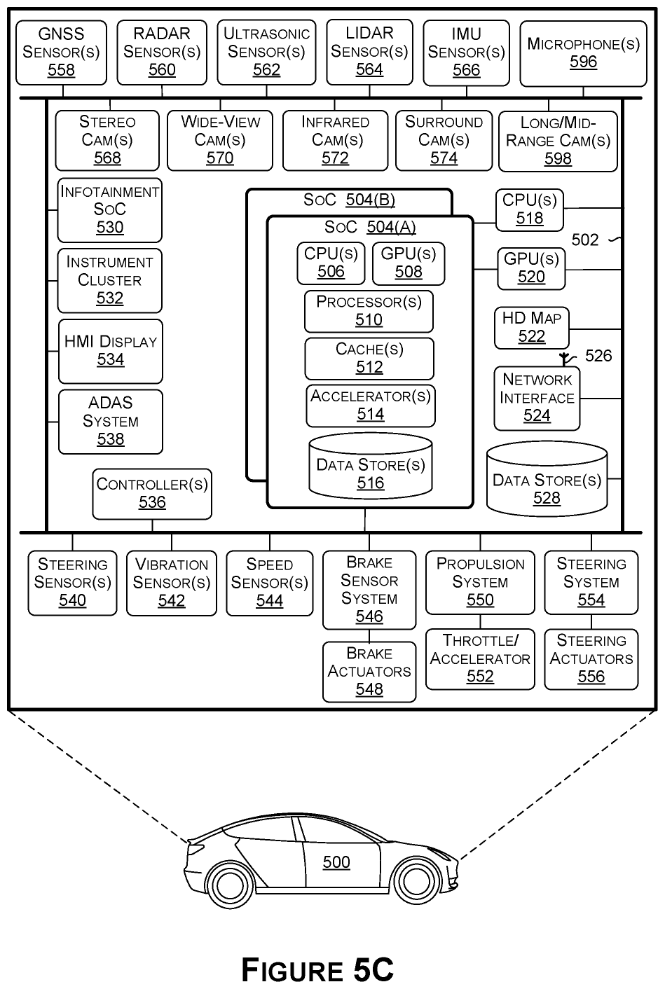

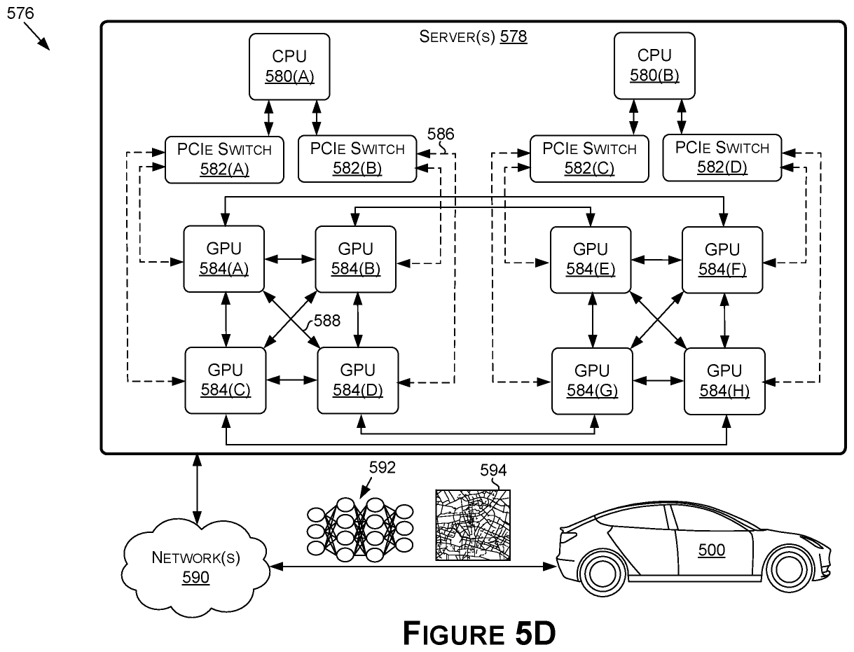

Systems and methods are disclosed related to intelligent map data management and eviction for autonomous and semi-autonomous systems and applications. Although the present disclosure may be described with respect to an example autonomous or semi-autonomous vehicle or machine 500 (alternatively referred to herein as “vehicle 500,” “ego-vehicle 500,” “machine 500,” or “ego-machine 500,” an example of which is described with respect to FIGS. 5A-5D), this is not intended to be limiting. For example, the systems and methods described herein may be used by, without limitation, location-aware systems that are capable of detecting, computing, and/or utilizing the geographical position of a person, a mobile device, and/or a moving object. These location-aware systems may be included in and/or used in conjunction with non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to map data management and eviction for autonomous or semi-autonomous machine applications, this is not intended to be limiting, and the systems and methods described herein may be used in augmented reality, virtual reality, mixed reality, robotics, security and surveillance, autonomous or semi-autonomous machine applications, and/or any other technology spaces where data management and/or eviction may be used.

As discussed herein, map data that is used by a vehicle to provide location-based services is typically downloaded and stored in limited on-chip memory. As the vehicle drives to a new geographic area, additional map data for the new geographic area is downloaded and stored in the memory so that the vehicle can continue to provide these services in the new geographic areas. However, the limited storage capacity of the on-chip memory generally necessitates eviction of at least some existing map data in the memory to make room for the newly downloaded map data. At the same time, conventional unintelligent approaches for evicting stored map data in response to newly downloaded map data may cause existing map data that is likely to be needed in the (e.g., near) future to be deleted, which incurs additional resource overhead and potential latency when the deleted map data is subsequently redownloaded.

To improve the management and use of map data in location-aware systems with limited memory, the disclosed techniques compute priority scores for discrete units of map data that are downloaded in response to vehicular movement and stored in memory on an in-vehicle SoC (or another location-aware system, hardware type, memory type, etc.). These map data units may include map tiles, layers within map tiles, and/or other discrete portions of map data. The priority scores may be computed based on attributes of the map data units, such as (but not limited to) recency of use, frequency of use, distance from a current location of the location-aware system, overlap with a frequent or known route of the location-aware system, a map data unit size, a time of day, and/or a day of the week. Each priority score may represent a likelihood of use for a corresponding map data unit and/or another measure of a potential “cost” associated with evicting the map data unit. One or more map data units with priority scores representing the lowest potential cost(s) of eviction may then be deleted in response to new map data to be stored in the memory.

One technical advantage of the disclosed techniques relative to prior approaches is the ability to efficiently use limited memory to store and update map data on a location-aware system. In this regard, the techniques prioritize map data units for eviction based on various attributes that are relevant to subsequent use of the map data units and/or costs associated with downloading the map data units, thereby reducing the likelihood that evicted map data will subsequently need to be redownloaded. Consequently, the disclosed techniques improve data reuse, network utilization, and resource overhead when compared with conventional, naïve approaches for managing and updating stored map data.

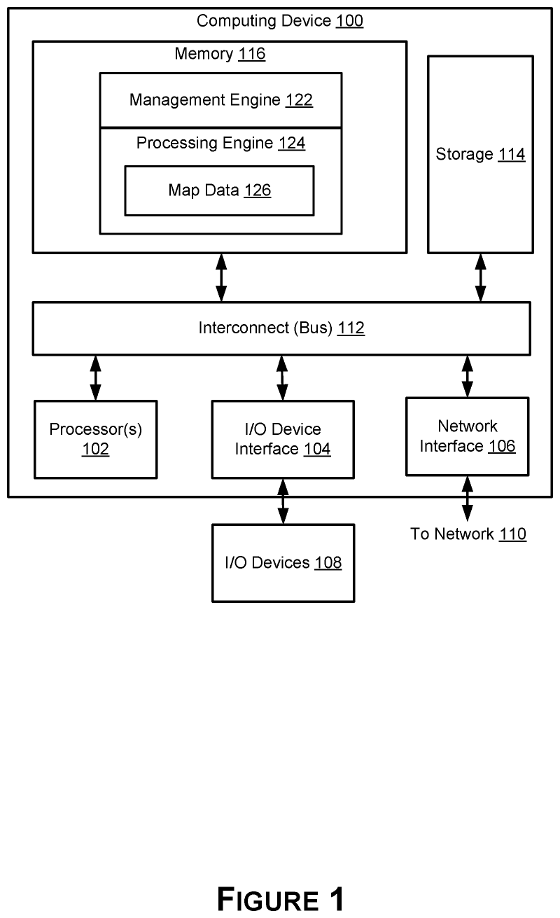

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system(s) on a chip(s), an in-vehicle computing device, and/or any other type of computing device configured to receive input, process data, and optionally display images, and is suitable for practicing one or more embodiments. Computing device 100 is configured to run a management engine 122 and a processing engine 124 that may reside in a memory 116. It is noted that the computing device described herein is illustrative and that any other technically feasible configurations fall within the scope of the present disclosure. For example, multiple instances of management engine 122 and/or processing engine 124 may execute on a set of nodes in a distributed and/or cloud computing system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a parallel processing unit (PPU), a data processing unit (DPU), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center) and/or may correspond to a virtual computing instance executing within a computing cloud.

In at least one embodiment, I/O devices 108 include devices capable of receiving input, such as a keyboard, a mouse, a touch screen, a touchpad, a VR/MR/AR headset, a gesture recognition system, and/or a microphone, as well as devices capable of providing output, such as a display device(s), a haptic device(s), and/or a speaker(s). Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, a cellular network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Management engine 122 and/or verification engine 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs that can be executed by processor(s) 102 and application data associated with said software programs, including management engine 122 and/or processing engine 124.

Management engine 122 and processing engine 124 include functionality to manage map data 126 stored in memory 116. For example, memory 116 may be included in an on-board system-on-chip (SoC) of a vehicle. During operation of the vehicle, map data 126 may be received network 110 via network interface 106 and stored in memory 116 to allow the vehicle to perform localization, planning, navigation, and/or other location-based tasks. As the vehicle moves to new geographic areas, additional map data 126 for the new geographic areas is downloaded and stored in memory 116. Because memory 116 in the SoC is limited, the additional map data 126 is typically accommodated within memory 116 by evicting at last some of the existing map data 126 from memory 116.

In one or more embodiments, management engine 122 computes priority scores for discrete units of map data 126 stored in memory 116, which are also referred to herein as map data units. These map data units may include (but are not limited to) map tiles, layers within map tiles, and/or other discrete portions of map data. The priority scores may be computed based on attributes of the map data units, such as (but not limited to) recency of use, frequency of use, distance from a current location of the location-aware system, overlap with a frequent or known route of the location-aware system, a map data unit size, a time of day, and/or a day of the week. Each priority score may represent a likelihood of use for a corresponding map data unit and/or another measure of a potential “cost” associated with evicting the map data unit.

Management engine 122 generates a ranking of these map data units by the corresponding priority scores and uses the ranking to select one or more map data units as candidates for eviction. As new map data 126 is received over network 110 and network interface 106 for storage in memory 116, processing engine 124 makes room for the newly downloaded map data 126 by deleting map data units identified as candidates for eviction by management engine 122 from memory 116. The operation of management engine 122 and processing engine 124 is descried in further detail below.

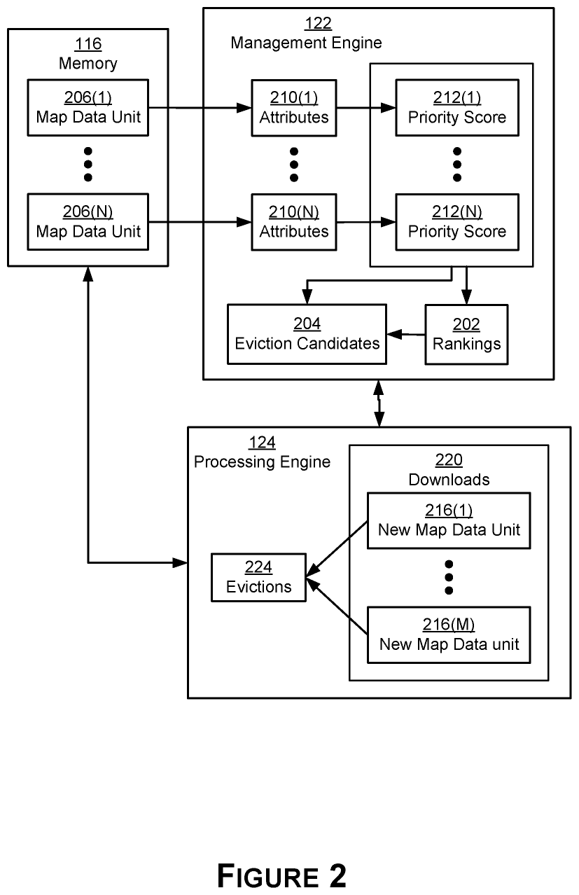

FIG. 2 is a more detailed illustration of management engine 122 and processing engine 124 of FIG. 1, according to various embodiments. As discussed herein, management engine 122 and processing engine 124 operate to manage the storage and eviction of a number of map data units 206(1)-206(N) (each of which is referred to individually herein as map data unit 206) in memory 116 on a location-aware system.

In some embodiments, map data units 206 include discrete units of geographically indexed map data that can be used to perform tasks such as (but not limited to) geolocation, mapping, navigation, and/or vehicular planning. For example, map data units 206 may include map tiles that correspond to contiguous rectangles, squares, cells, hexagons, polygons, and/or other shapes into which a map is divided. These map tiles may be associated with multiple “zoom” levels, such that a map tile at a lower zoom level may include data that encompasses a broader area (e.g., an entire city), while a map tile at a higher zoom level may include more detailed information for a smaller area (e.g., a single building or city block). Map data units 206 may also, or instead, include individual layers into which data within a given map tile is organized. Each layer may store a different type of data for the region represented by the map tile, such as (but not limited to) images, roads, interstates, road surface markings, traffic signs, radar points, traffic conditions, weather conditions, network conditions, landmarks, topography, and/or metadata.

As shown in FIG. 2, management engine 122 determines a different set of attributes 210(1)-210(N) (each of which is referred to individually herein as attributes 210) for each of map data units 206(1)-206(N). In some embodiments, each set of attributes 210 includes information that can be used to characterize historical, current, and/or future usage of the corresponding map data unit 206 by the location-aware system. For example, attributes 210 may include (but are not limited to) a last time of use, frequency of use, geographic distance from a current location of the location-aware system, alignment (e.g., overlap, proximity, etc.) with a frequent or known route of the location-aware system, time of day, and/or day of the week. One or more attributes 210 may also, or instead, characterize a “cost” associated with downloading, storing, and/or evicting the corresponding map data unit 206. For example, attributes 210 may include (but are not limited to) a size of a corresponding map data unit 206, a type of data (e.g., images, roads, interstates, etc.) stored in the corresponding map data unit 206, an importance of the data stored in the corresponding map data unit 206 to one or more tasks (e.g., mapping, navigation, vehicular planning, etc.) performed by the location-aware system, a number of requests for data stored in the corresponding map data unit 206, and/or a download time associated with the corresponding map data unit 206.

It will be appreciated that management engine 122 may use various techniques to determine attributes 210 for each map data unit 206. For example, management engine 122 may analyze requests, memory 116 accesses, logs, and/or other historical data associated with map data units 206 to identify trends in the frequency of use, recency of use, download times, and/or other data related to the download, storage, and/or usage of each map data unit 206. Management engine 122 may also, or instead, use system calls and/or configuration data to determine the size of each map data unit 206, the importance of each map data unit 206 to the operation of the location-aware system, the type of data stored in a given map data unit 206, the current location of the location-aware system, and/or the proximity of the location-aware system to regions represented by map data units 206.

Management engine 122 may also, or instead, use predictive analytics to forecast the likelihood of future use and/or a usage pattern for each map data unit 206. These predictive analytics may involve machine learning and/or time series analysis techniques to account for and/or determine correlations across times of day, days of the week, seasonal patterns, weather conditions, road conditions, network conditions, and/or other factors that may influence the operation of the location-aware system and/or the ability of the location-aware system to download and/or use map data units 206.

Management engine 122 uses attributes 210(1)-210(N) for each of map data units 206(1)-206(N) to compute priority scores 212(1)-212(N) (each of which is referred to individually herein as priority score 212) for individual map data units 206(1)-206(N). Each priority score 212 represents a likelihood that the corresponding map data unit 206 will be reused within a certain timeframe, a measure of overhead associated with downloading the corresponding map data unit 206, and/or another measure of a potential “cost” associated with evicting the corresponding map data unit 206.

In one or more embodiments, management engine 122 computes priority scores 212 using a set of heuristics and/or rules, which may be specified and/or defined based on domain knowledge and/or parameters associated with the use of location-aware system. For example, management engine 122 may compute priority scores 212 as numeric positions of the corresponding map data units 206 in one or more rankings 202. In this example, management engine 122 may generate multiple “buckets” representing different ranges of recency of use of map data units 206 (e.g., ranges of elapsed time since map data units 206 were last used). Within a given bucket, management engine 122 may generate a ranking of the corresponding map data units 206 by frequency of use. The priority score for a given map data unit 206 may then be determined as the position of the bucket in which that map data unit 206 can be found, as well as the position of that map data unit 206 within the ranking of map data units 206 in the bucket.

Management engine 122 also, or instead, computes each priority score 212 as a weighted combination of the corresponding set of attributes 210. For example, management engine 122 may associate each attribute with a weight representing the relative importance of the attribute to the process of evicting map data units 206 from memory 116. The weight may be determined by one or more users, regression and/or other statistical analysis techniques, and/or other methods. Each attribute may be combined with (e.g., multiplied by) the corresponding weight to obtain a weighted attribute, and priority score 212 for a given map data unit 206 may be computed as an aggregation (e.g., sum, arithmetic mean, geometric mean, etc.) of weighted attributes 210 for that map data unit 206.

Management engine 122 also, or instead, uses one or more machine learning models to compute priority scores 212 from attributes 210 for the corresponding map data units 206. Each machine learning model may include (but is not limited to) a neural network, support vector machine, tree-based model, regression model, hierarchical model, ensemble model, time series analysis model, and/or another type of model that is capable of performing general-purpose or specialized artificial intelligence-oriented operations. The machine learning model(s) may be trained using historical data related to download and usage of map data units across one or more location-aware systems, which may include or exclude the location-aware system on which management engine 122 and processing engine 124 execute. During training, parameters of each machine learning model may be updated so that the machine learning model outputs a binary score indicating a whether or not a map data unit will be reused within a certain forward-looking time period, given input that includes attributes associated with the map data unit from one or more time periods preceding the forward-looking time period. After the machine learning model is trained, additional sets of attributes 210 for map data units 206 stored in memory 116 may be inputted into the machine learning model, and the machine learning model may generate a priority score ranging between 0 and 1 that indicates the likelihood that the corresponding map data unit will be used within a certain timeframe corresponding to the forward-looking time period. The machine learning model(s) may also be retrained (e.g., on a periodic and/or continuous basis) using attributes 210, priority scores 212, and/or outcomes associated with map data units 206 to adapt the machine learning model to usage patterns associated with the location-aware system. The retrained machine learning model(s) may then be used to convert attributes 210 for subsequent map data units 206 into priority scores 212 that better reflect the costs and/or outcomes associated with evicting map data units 206 from memory 116 on the location-aware system.

It will be appreciated that heuristics, weights, and/or machine learning models used by management engine 122 may be used to generate priority scores 212 representing a variety of values and/or metrics, and that these values and/or metrics may be used to perform evictions 224 of map data units 206 according to different priorities. For example, management engine 122 may convert a given set of attributes 210 into a priority score representing a cost associated with redownloading a corresponding map data unit 206 if that map data unit were to be evicted and later requested again. Attributes 210 that may contribute to this type of priority score may include (but are not limited to) the size of the map data unit, current and/or projected network bandwidth, and/or estimated and/or historical download times for the map data unit. This cost-based priority score may be used to improve latency, responsiveness, and/or resource consumption of the location-aware system.

In another example, management engine 122 may convert a given set of attributes 210 into a priority score representing the contextual relevance of a corresponding map data unit 206 to a current and/or predicted context (e.g., location, route, task, etc.) of the location-aware system. Attributes used to compute this score may include (but are not limited to) historical route data, planned future routes, traffic conditions, weather conditions, and/or points of interest or common destinations within the region represented by that map data unit 206. This context-based score may facilitate the retention of map data units 206 that are in the vicinity of the trajectory of the vehicle, areas that the vehicle is likely to visit, and/or areas frequented by the vehicle.

In a third example, management engine 122 may convert a given set of attributes 210 into a priority score that is computed from the age and expected update frequency of the data stored in the corresponding map data unit 206. Thus, map data units 206 that store frequently changing data (e.g., traffic conditions, construction updates, etc.) may have priority scores 212 that result in a higher likelihood of eviction than map data units 206 that store less frequently changing data (e.g., roads, traffic signs, landmarks, etc.). This type of priority score may thus be used to target map data units that are outdated or stale for eviction.

In a fourth example, management engine 122 may combine one or more of the above types of priority scores into a “composite” priority score 212 that represents an overall measure of the utility of a corresponding map data unit 206 This composite priority score 212 may allow management engine 122 to balance multiple objectives associated with managing the storage and eviction of map data units 206 in memory 116.

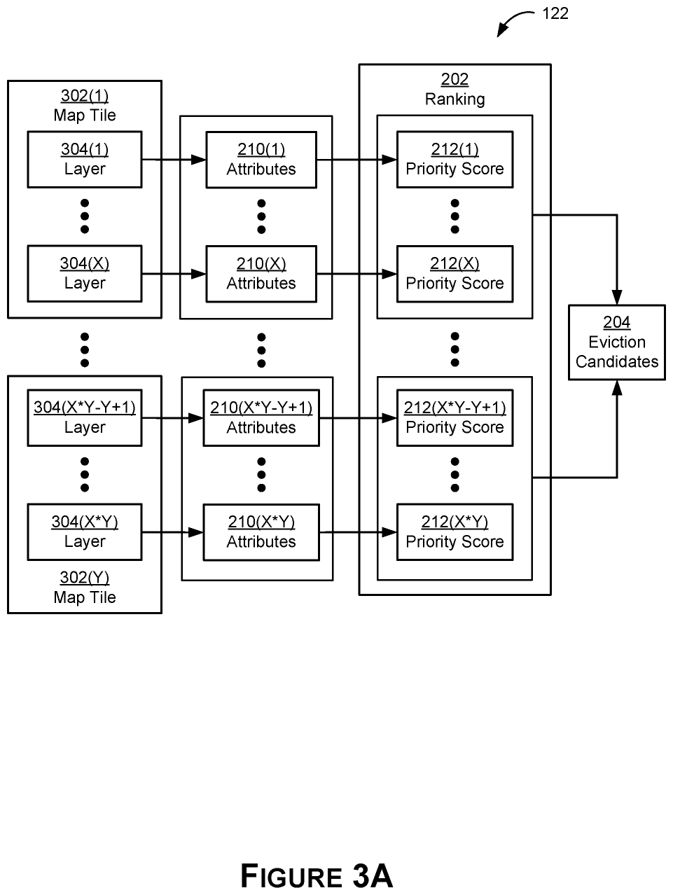

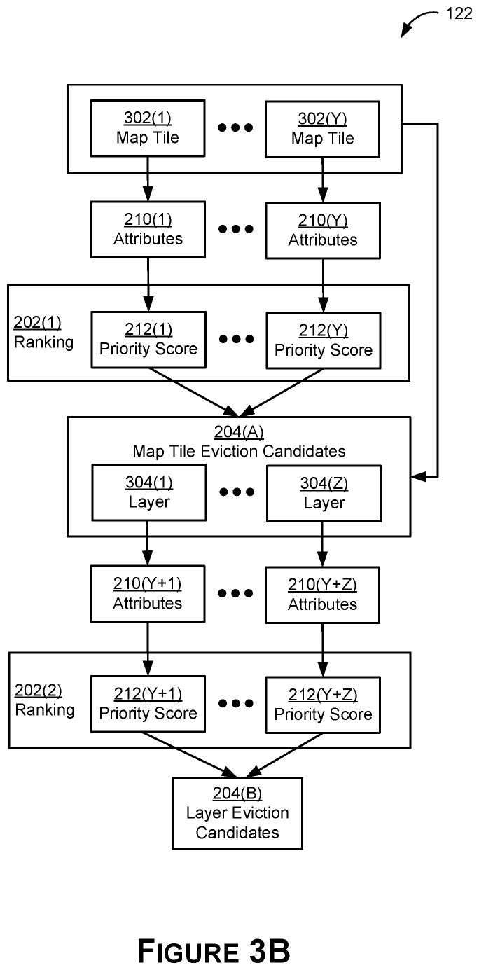

After priority scores 212 are computed for map data units 206, management engine 122 generates one or more rankings 202 of map data units 206 by the corresponding priority scores 212. Management engine 122 also uses rankings 202 and/or priority scores 212 to select one or more map data units 206 from rankings 202 as eviction candidates 204. For example, management engine 122 may select, as eviction candidates 204, a prespecified number of map data units 206 with positions in rankings 202 that represent the lowest likelihood of reuse, download cost, contextual relevance, and/or likelihood of being up to date. In another example, management engine 122 may select a prespecified and/or variable number of map data units 206 with priority scores 212 that fall below a threshold as eviction candidates 204. Techniques for determining eviction candidates 204 from priority scores 212 and/or rankings 202 are described in further detail below with respect to FIGS. 3A and 3B.

Management engine 122 transmits eviction candidates 204 to processing engine 124, and processing engine 124 uses eviction candidates 204 to perform evictions 224 of map data units 206 from memory 116. For example, management engine 122 may periodically and/or continuously select and transmit eviction candidates 204 to processing engine 124. As processing engine 124 detects and/or receives downloads 220 of new map data units 216(1)-216(M) (each of which is referred to individually herein as new map data unit 216), processing engine 124 may perform evictions 224 of one or more map data units 206 from the most recent eviction candidates 204 to make room for the downloaded new map data units 216. These evictions 224 may be performed based on priority scores 212 for map data units 206 in eviction candidates 204, the sizes of map data units 206 in eviction candidates 204, and/or other criteria.

FIG. 3A illustrates the example operation of management engine 122 of FIG. 1 in determining a set of eviction candidates 204, according to various embodiments. In the example of FIG. 3A, management engine 122 operates on map data units 206 that include individual layers 304(1)-304(X) and 304(X*Y−Y+1)-304(X*Y) within a set of map tiles 302(1)-302(Y) (each of which is referred to individually herein as map tile 302). As mentioned herein, map tiles 302 may include rectangular, hexagonal, square, and/or other types of discrete regions into which map data is divided. Each map tile 302 may store various types of data (e.g., images, roads, interstates, road surface markings, traffic signs, radar points, traffic conditions, weather conditions, landmarks, topography, metadata, etc.) in different layers 304.

More specifically, management engine 122 determines a set of attributes 210(1)-210(X) and 210(X*Y−Y+1)-210(X*Y) for each of layers 304(1)-304(X) and 304(X*Y−Y+1)-304(X*Y). For example, management engine 122 may use attributes 210 such as (but not limited to) a layer size, a layer importance, a number of requests associated with a layer, a staleness of data in a layer, and/or a download time associated with a layer to compute priority scores 212 representing the costs of evicting the corresponding layers 304.

Management engine 122 also converts each set of attributes 210(1)-210(X) and 210(X*Y−Y+1)-210(X*Y) into a corresponding priority score 212(1)-212(X) and 212(X*Y−Y+1)-212(X*Y). Management engine 122 then generates a ranking 202 of layers 304 by priority scores 212 and selects eviction candidates 204 from ranking 202. Thus, in this example, management engine 122 uses layers 304 in map tiles 302 as map data units 206 that can be selected as eviction candidates 204.

FIG. 3B illustrates the example operation of management engine 122 of FIG. 1 in determining a set of eviction candidates 204, according to various embodiments. In the example of FIG. 3B, management engine 122 uses map tiles 302(1)-302(Y) as a first type of map data unit 206 for which attributes 210(1)-210(Y) and priority scores 212(1)-212(Y) are determined. For example, management engine 122 may use attributes 210 such as (but not limited to) a last time of use, a frequency of use, a geographic distance from a current location of the location-aware system, an overlap with a route associated with a vehicle, a map tile size, a time of day, and/or a day of the week to compute priority scores 212 representing the likelihoods of reusing the corresponding map tiles 302.

Management engine 122 generates a ranking 202(1) of map tiles 302(1)-302(Y) by the corresponding priority scores 212(1)-212(Y) and selects one or more map tile eviction candidates 204(A) from ranking 202(1). Continuing with the above example, management engine 122 may select map tile eviction candidates 204(A) as one or more map tiles 302(1)-302(Y) with priority scores 212 that represent the lowest likelihood of being reused.

Management engine 122 then uses layers 304(1)-304(Z) in one or more map tiles 302 corresponding to map tile eviction candidates 204(A) as a second type of map data unit 206 for which additional attributes 210(Y+1)-210(Y+Z) and priority scores 212(Y+1)-212(Y+Z) are determined. For example, management engine 122 may use attributes 210(Y+1)-210(Y+Z) such as (but not limited to) a layer size, a layer importance, a number of requests associated with a layer, a staleness of data in a layer, and/or a download time associated with a layer to compute priority scores 212(Y+1)-212(Y+Z) representing the costs of evicting the corresponding layers 304(1)-304(Z).

Management engine 122 generates another ranking 202(2) of layers 304(1)-304(Z) by the corresponding priority scores 212(Y+1)-212(Y+Z) and selects one or more layer eviction candidates 204(A) from ranking 202(2). Continuing with the above example, management engine 122 may select layer eviction candidates 204(B) as one or more layers 304(1)-304(Z) with priority scores 212(Y+1)-212(Y+Z) that represent the lowest cost of eviction.

By selecting eviction candidates 204 from individual layers 304 of map tiles 302 in the examples of FIGS. 3A and 3B, management engine 122 may perform finer-grained, intelligent eviction of map data units 206 than naïve or unintelligent approaches that evict entire map tiles from memory to make room for newly downloaded map tiles. For example, the examples of FIGS. 3A and 3B may allow management engine 122 to prioritize eviction of larger layers such as images and/or road geometry. The examples of FIGS. 3A and 3B may also, or instead, allow management engine 122 to avoid and/or reduce eviction of smaller, more important layers, such as metadata layers that store manifests, signatures, and/or other information that is needed to download, verify, and/or use other layers in the corresponding map tiles 302.

While the operation of management engine 122 has been described with respect to FIGS. 3A and 3B as selecting eviction candidates 204 based on map data units 206 that include layers 304 in map tiles 302 and both map tiles 302 and layers 304, respectively, it will be appreciated that management engine 122 may select eviction candidates 204 based on other types and/or combinations of map data units 206. For example, management engine 122 may compute priority scores 212 for individual layers 304 based on attributes of both these layers 304 and map tiles 302 in which the layers are found. Management engine 122 may then use these priority scores 212 to select one or more layers 304 and/or one or more map tiles 302 as eviction candidates 204. In another example, management engine 122 may compute priority scores 212 and/or select eviction candidates 204 from groupings of map tiles 302 and/or layers 304. In a third example, management engine 122 may compute priority scores 212 and/or select eviction candidates 204 from blocks, pages, and/or other units of memory 116, in lieu of or in addition to computing priority scores 212 and/or selecting eviction candidates 204 from map tiles 302 and/or layers 304.

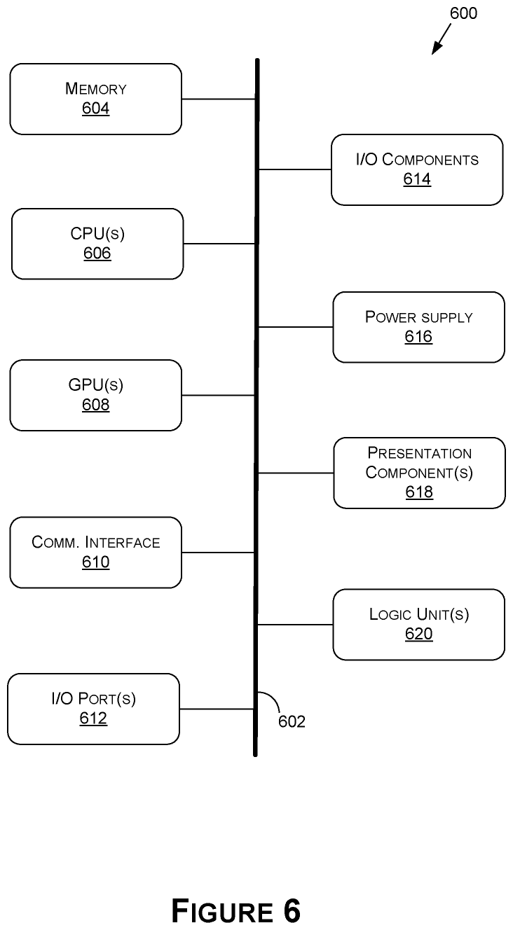

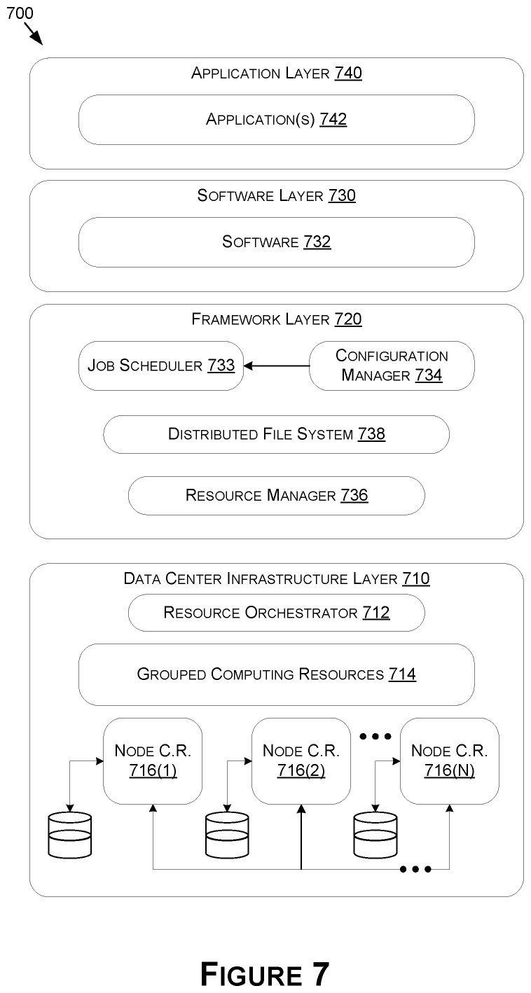

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 500 of FIGS. 5A-5D, example computing device 600 of FIG. 6, and/or example data center 700 of FIG. 7.

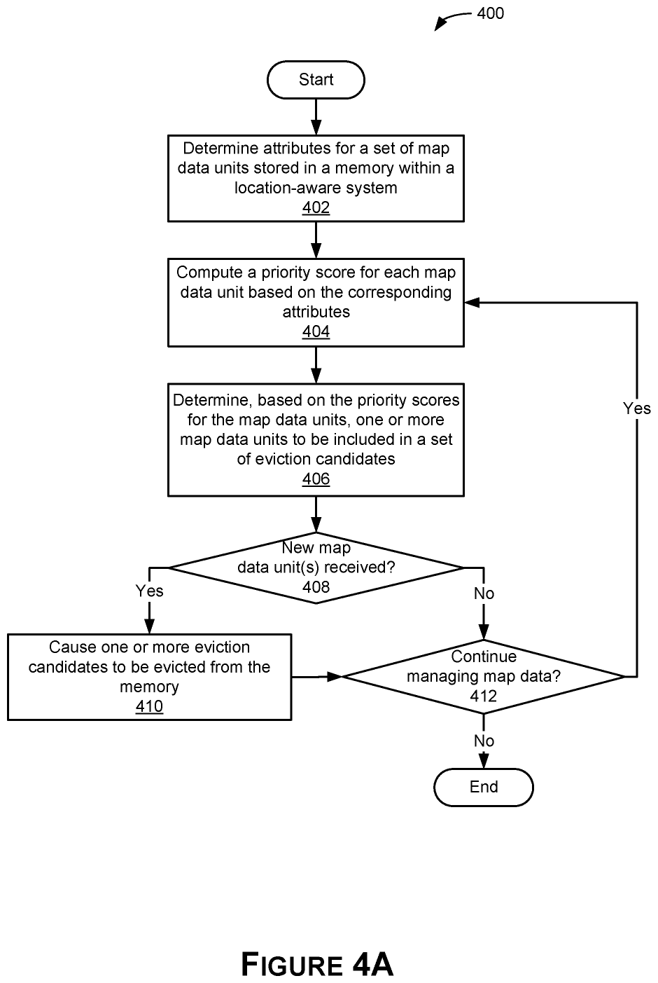

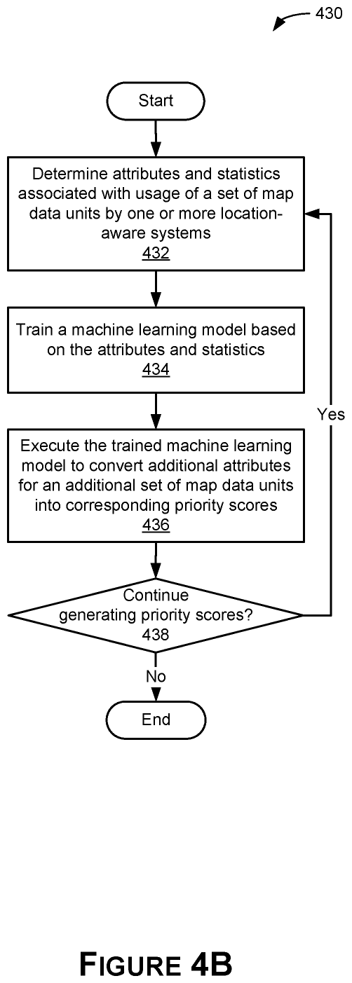

Now referring to FIGS. 4A-4B, each block of methods 400 and 430, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method(s) 400 and 430 are described, by way of example, with respect to the system of FIG. 1. However, these methods may additionally or alternatively be executed by any one system, or any combination of systems, including, but not limited to, those described herein.

FIG. 4A illustrates a flow diagram showing a method 400 for managing map data stored in a location-aware system, in accordance with some embodiments of the present disclosure. As shown in FIG. 4A, method 400 begins with operation 402, in which management engine 122 determines attributes for a set of map data units stored in a memory within a location-aware system. For example, the map data units may include map tiles representing discrete geographic regions into which map data is divided. Attributes associated with the map tiles may include (but are not limited to) a last time of use, a frequency of use, a geographic distance from a current location of the location-aware system, an overlap with a route associated with a vehicle, a map tile size, a time of day, and/or a day of the week. The map data units may also, or instead, include layers within the map tiles. Attributes associated with the layers may include (but are not limited to) a layer size, a layer importance, a number of requests associated with a layer, a staleness of a layer, and/or a download time associated with a layer.

In operation 404, management engine 122 computes a priority score for each map data unit based on the corresponding attributes. For example, management engine 122 may use a set of rules and/or heuristics to generate a priority score for each map data unit based on some or all of the corresponding attributes. Management engine 122 may also, or instead, generate a priority score for each map data unit as a weighted combination of the corresponding attributes. Management engine 122 may also, or instead, use a machine learning model to convert attributes for a given map data unit into a corresponding priority score, as described in further detail below with respect to FIG. 5. Each priority score may represent a likelihood of reuse of the corresponding map data unit, a cost associated with redownloading the map data unit, an amount of memory reclaimed in evicting the map data unit, and/or another measure related to a potential consequence of evicting the map data unit.

In operation 406, management engine 122 determines, based on the priority scores for the map data units, one or more map data units to be included in a set of eviction candidates. For example, management engine 122 may generate one or more rankings of the map data units by the priority scores. Management engine 122 may also use the ranking(s) and/or priority scores to select one or more map data units with priority scores that represent the lowest cost of eviction (or highest upside of eviction) for inclusion in the set of eviction candidates.

In operation 408, processing engine 124 determines whether or not one or more new map data units have been received for storage in the memory. For example, processing engine 124 may download the new map data unit(s) over a network, receive events related to downloads of the new map data unit(s), and/or otherwise detect the new map data unit(s).

If one or more new map data units have been received, processing engine 124 performs operation 410, in which processing engine 124 causes one or more eviction candidates to be evicted from the memory. For example, processing engine 124 may select, from the set of eviction candidates, one or more map data units to be evicted from the memory. Processing engine 124 may also output the selected map data unit(s), generate one or more system calls to delete the selected map data unit(s) and/or overwrite the selected map data unit(s) with the new map data unit(s), and/or perform other operations to effect the eviction of the selected map data unit(s) from the memory.

If processing engine 124 determines that no new map data units have been received and/or performs operation 410 to evict one or more map data units from the memory, management engine 122 performs operation 412, in which management engine 122 determines whether or not to continue managing map data. For example, management engine 122 may determine that management of map data is to continue while the memory is used to store map data and/or during operation of the location-aware system.

While map data continues to be managed, management engine 122 and processing engine 124 repeat operations 402, 404, 406, 408, 410, and 412 on a periodic and/or continuous basis. For example, management engine 122 may perform operations 402, 404, and 406 to generate up-to-date attributes, priority scores, and eviction candidates from map data units stored in the memory. Management engine 122 and processing engine 124 may then perform operations 408, 410, and/or 412 to accommodate any new map data units received for storage in the memory. Management engine 122 and processing engine 124 may continue using method 400 to manage the storage and eviction of map data from the memory until the memory, map data, and/or location-aware system are no longer used.

FIG. 4B illustrates a flow diagram showing a method 430 for generating priority scores for map data units using a machine learning model, in accordance with some embodiments of the present disclosure. As shown in FIG. 4A, method 430 begins with operation 432, in which management engine 122 determines attributes and statistics associated with usage of a set of map data units by one or more location-aware systems. For example, management engine 122 may collect and/or analyze historical data associated with map data units stored in the location-aware system(s). Management engine 122 may determine a set of attributes for a map data unit from historical data that falls within a first time period and one or more statistics for the map data unit from historical data that falls within a second time period that follows the first time period. The attributes may include values related to the usage of the map data unit, data in the map data unit, and/or the operation of the corresponding location-aware system during the first time period. The statistic(s) may include values related to subsequent use, eviction, and/or redownloading of the map data unit by the location-aware system during the second time period.

In operation 434, management engine 122 trains a machine learning model based on the attributes and statistics. For example, management engine 122 may input a set of attributes for each map data unit into the machine learning model and execute the machine learning model to obtain output that includes predictions of outcomes represented by the corresponding statistics. Management engine 122 may also compute one or more losses between the predictions and the statistics and use a training technique (e.g., gradient descent and backpropagation) to iteratively update parameters of the machine learning model in a way that reduces the losses.

In operation 436, management engine 122 executes the trained machine learning model to convert additional attributes for an additional set of map data units into corresponding priority scores. For example, management engine 122 may perform operation 436 to generate priority scores that can be used to selectively evict map data units that are currently stored in memory on one or more location-aware systems, as discussed herein. The additional set of map data units may be stored in the same location-aware system(s) as the set of map data units used to train the machine learning model in operations 432 and 434. One or more map data units in the additional set of map data units may also, or instead, be stored in one or more location-aware systems that differ from the location-aware system(s) from which training data for the machine learning model was obtained.

In operation 438, management engine 122 determines whether or not to continue generating priority scores. For example, management engine 122 may determine that priority stores should continue to be generated while the machine learning model is used to generate the priority scores, while the priority scores are used to manage the storage and eviction of map data units in memory on one or more location-aware systems, and/or based on other conditions or criteria. While management engine 122 determines that priority scores should continue to be generated, management engine 122 may repeat operations 432 and 434 to retrain the machine learning model using the latest attributes and statistics from one or more location-aware systems. Management engine 122 may also repeat operations 436 and 438 to use the retrained machine learning models to generate priority scores for additional map data units on the same location-aware system(s) and/or different location-aware system(s) and determine whether or not to continue generating priority scores using the machine learning model. Consequently, management engine 122 may use method 430 to continuously update the machine learning model and priority scores as new data becomes available and/or as the usage patterns of the location-aware system(s) change.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implementing one or more language models-such as one or more large language models (LLMs), systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., map data 126, map data units 206, the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D). As discussed herein, these map refreshes and/or updates may be managed by selectively evicting map tiles, layers, and/or other map data units from cache(s) 512, data store(s) 516, and/or other types of storage or memory in SoC 504 based on attributes and/or priority scores associated with the map data units.

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 500 m, with an accuracy of 2 cm-3 cm, and with support for a 500 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers). As discussed herein, one or more neural networks 592 and/or one or more updated neural networks 592 may be used to generate priority scores representing likelihoods of reuse, cost of eviction, and/or other measures associated with storage, deletion, and/or use of the map information 594 on the vehicle 500.

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se. As discussed herein, memory 604 may store map tiles, layers, and/or other map data units for use in performing geolocation, navigation, planning, and/or other tasks on a location-aware system. These map data units may be selectively stored in and/or evicted from memory 604 based on attributes and/or priority scores associated with the map data units.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein. For example, the trained or deployed machine learning models may be used to generate priority scores that can be used to manage the storage and eviction of map data units in memory on one or more remote location-aware systems.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In sum, the disclosed techniques compute priority scores for discrete units of map data that are downloaded in response to vehicular movement and stored in memory on an in-vehicle SoC (or another location-aware system). These map data units may include map tiles, layers within map tiles, and/or other discrete portions of map data. The priority scores may be computed based on attributes of the map data units, such as (but not limited to) recency of use, frequency of use, distance from a current location of the location-aware system, overlap with a frequent or known route of the location-aware system, a map data unit size, a time of day, and/or a day of the week. Each priority score may represent a likelihood of use for a corresponding map data unit and/or another measure of a potential “cost” associated with evicting the map data unit. One or more map data units with priority scores representing the lowest potential cost(s) of eviction may then be deleted in response to new map data to be stored in the memory.

One technical advantage of the disclosed techniques relative to prior approaches is the ability to efficiently use limited memory to store and update map data on a location-aware system. In this regard, the techniques prioritize map data units for eviction based on various attributes that are relevant to subsequent use of the map data units and/or costs associated with downloading the map data units, thereby reducing the likelihood that evicted map data will subsequently need to be redownloaded. Consequently, the disclosed techniques improve data reuse, network utilization, and resource overhead when compared with conventional, naïve approaches for managing and updating stored map data.
1. In some embodiments, a method comprises determining a corresponding set of attributes for individual map data units of a plurality of map data units stored in memory of a location-aware system; for the individual map data units included in the plurality of map data units, computing a priority score for the individual map data unit based on the set of attributes corresponding to the individual map data unit; determining, based on the plurality of priority scores for the plurality of map data units, one or more map data units to be evicted from the memory; and causing at least a portion of the one or more map data units to be at least one of deleted from or replaced in the memory in response to receiving one or more new map data units for storage in the memory.
2. The method of clause 1, wherein the computing the priority score comprises inputting the corresponding set of attributes for the individual map data unit into a machine learning model; and generating, via execution of the machine learning model, the priority score representing a likelihood of reusing the individual map data unit.
3. The method of any of clauses 1-2, further comprising determining a plurality of statistics associated with usage of a second plurality of map data units by one or more location-aware systems; and updating one or more parameters of a machine learning model based at least on the plurality of statistics and the plurality of sets of attributes, wherein the priority score is computed using the updated machine learning model based at least on input that includes the corresponding set of attributes.
4. The method of any of clauses 1-3, wherein the priority score is computed based at least on a weighted combination of the corresponding set of attributes.
5. The method of any of clauses 1-4, wherein the determining the one or more map data units to be evicted comprises determining, from the plurality of priority scores, one or more priority scores indicating a lowest cost associated with evicting the one or more map data units.
6. The method of any of clauses 1-5, wherein the determining the one or more map data units to be evicted comprises determining one or more layers corresponding to the one or more map data units to be deleted from a map tile based on a set of additional attributes associated with the one or more layers.
7. The method of any of clauses 1-6, wherein the set of additional attributes comprises at least one of a layer size, a layer importance, a number of requests associated with a layer, a staleness of a layer, or a download time associated with a layer.
8. The method of any of clauses 1-7, wherein the plurality of map data units comprises at least one of a plurality of map tiles or a plurality of layers included in the plurality of map tiles.
9. The method of any of clauses 1-8, wherein each set of attributes included in the plurality of sets of attributes comprises at least one of a last time of use, a frequency of use, a geographic distance from a current location of the location-aware system, an overlap with a route associated with a vehicle, a map data unit size, a time of day, or a day of the week.
10. The method of any of clauses 1-9, wherein the location-aware system comprises at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a mobile device; a system for generating or presenting at least one of virtual reality content, augmented reality content, or mixed reality content; a system implemented using a robot; a system for performing conversational AI operations; a system for generating synthetic data; a system incorporating one or more virtual machines (VMs); a system implemented at least partially in a data center; or a system implemented at least partially using cloud computing resources.
11. In some embodiments, a processor comprises one or more circuits to perform operations comprises determining a corresponding set of attributes for each of a plurality of map data units stored in memory of a location-aware system; for each map data unit included in the plurality of map data units, computing a priority score for the map data unit based on the set of attributes corresponding to the map data unit; determining, based on the plurality of priority scores for the plurality of map data units, one or more map data units to be evicted from the memory; and causing at least a portion of the one or more map data units to be at least one of deleted from or replaced in the memory in response to receiving one or more new map data units for storage in the memory.
12. The processor of clause 11, wherein the computing the priority score comprises inputting the set of attributes corresponding to the map data unit into a machine learning model; and generating, via execution of the machine learning model, the priority score representing a likelihood of reusing the map data unit.
13. The processor of any of clauses 11-12, wherein the operations further comprise determining a plurality of statistics associated with usage of a second plurality of map data units by one or more location-aware systems; and updating one or more parameters of a machine learning model based on the plurality of statistics and the plurality of sets of attributes, wherein the priority score is computed by the updated machine learning model based at least on input that includes the corresponding set of attributes.
14. The processor of any of clauses 11-13, wherein the determining the one or more map data units to be evicted comprises determining, based at least on a subset of the plurality of priority scores for a plurality of map tiles included in the plurality of map data units, a priority score indicating a lowest cost associated with evicting a corresponding map tile included in the plurality of map tiles; and determining, based at least on a plurality of layers included in the corresponding map tile, a layer to be evicted from the memory.
15. The processor of any of clauses 11-14, wherein the layer to be evicted from the memory is determined based at least on a second subset of the plurality of priority scores for the plurality of layers.
16. The processor of any of clauses 11-15, wherein the set of attributes corresponding to each of the plurality of layers comprises at least one of a layer size, a layer importance, a number of requests associated with a layer, a staleness of a layer, or a download time associated with a layer.
17. The processor of any of clauses 11-16, wherein the set of attributes corresponding to each of the plurality of map tiles comprises at least one of a last time of use, a frequency of use, a geographic distance from a current location of the location-aware system, an overlap with a route associated with a vehicle, a map tile size, a time of day, or a day of the week.
18. The processor of any of clauses 11-17, wherein the processor is comprised in at least one of a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system for performing one or more generative AI operations; a system implementing one or more large language models (LLMs); a system for generating synthetic data; a system incorporating one or more virtual machines (VMs); a system implemented at least partially in a data center; or a system implemented at least partially using cloud computing resources.
19. In some embodiments, a system comprises one or more processing units to perform operations comprising determining a corresponding set of attributes for each of a plurality of map data units stored in a memory within a location-aware system; for each map data unit included in the plurality of map data units, computing a priority score for the map data unit based on the set of attributes corresponding to the map data unit; determining, based on the plurality of priority scores for the plurality of map data units, one or more map data units to be evicted from the memory; and causing at least a portion of the one or more map data units to be at least one of deleted from or replaced in the memory in response to receiving one or more new map data units for storage in the memory.
20. The system of clause 19, wherein the system is comprised in at least one of a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system for performing one or more generative AI operations; a system implementing one or more large language models (LLMs); a system for generating synthetic data; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining a corresponding set of attributes for individual map data units of a plurality of map data units stored in memory of a location-aware system;
for the individual map data units included in the plurality of map data units, computing a priority score for the individual map data unit based on the set of attributes corresponding to the individual map data unit;
determining, based on the plurality of priority scores for the plurality of map data units, one or more map data units to be evicted from the memory; and
causing at least a portion of the one or more map data units to be at least one of deleted from or replaced in the memory in response to receiving one or more new map data units for storage in the memory.

2. The method of claim 1, wherein the computing the priority score comprises:
inputting the corresponding set of attributes for the individual map data unit into a machine learning model; and
generating, via execution of the machine learning model, the priority score representing a likelihood of reusing the individual map data unit.

3. The method of claim 1, further comprising:
determining a plurality of statistics associated with usage of a second plurality of map data units by one or more location-aware systems; and
updating one or more parameters of a machine learning model based at least on the plurality of statistics and the plurality of sets of attributes, wherein the priority score is computed using the updated machine learning model based at least on input that includes the corresponding set of attributes.

4. The method of claim 1, wherein the priority score is computed based at least on a weighted combination of the corresponding set of attributes.

5. The method of claim 1, wherein the determining the one or more map data units to be evicted comprises determining, from the plurality of priority scores, one or more priority scores indicating a lowest cost associated with evicting the one or more map data units.

6. The method of claim 1, wherein the determining the one or more map data units to be evicted comprises determining one or more layers corresponding to the one or more map data units to be deleted from a map tile based on a set of additional attributes associated with the one or more layers.

7. The method of claim 6, wherein the set of additional attributes comprises at least one of a layer size, a layer importance, a number of requests associated with a layer, a staleness of a layer, or a download time associated with a layer.

8. The method of claim 1, wherein the plurality of map data units comprises at least one of a plurality of map tiles or a plurality of layers included in the plurality of map tiles.

9. The method of claim 1, wherein each set of attributes included in the plurality of sets of attributes comprises at least one of a last time of use, a frequency of use, a geographic distance from a current location of the location-aware system, an overlap with a route associated with a vehicle, a map data unit size, a time of day, or a day of the week.

10. The method of claim 1, wherein the location-aware system comprises at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a mobile device;
a system for generating or presenting at least one of virtual reality content, augmented reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

11. A processor comprising:
one or more circuits to perform operations comprising:
determining a corresponding set of attributes for each of a plurality of map data units stored in memory of a location-aware system;
for each map data unit included in the plurality of map data units, computing a priority score for the map data unit based on the set of attributes corresponding to the map data unit;
determining, based on the plurality of priority scores for the plurality of map data units, one or more map data units to be evicted from the memory; and
causing at least a portion of the one or more map data units to be at least one of deleted from or replaced in the memory in response to receiving one or more new map data units for storage in the memory.

12. The processor of claim 11, wherein the computing the priority score comprises:
inputting the set of attributes corresponding to the map data unit into a machine learning model; and
generating, via execution of the machine learning model, the priority score representing a likelihood of reusing the map data unit.

13. The processor of claim 11, wherein the operations further comprise:
determining a plurality of statistics associated with usage of a second plurality of map data units by one or more location-aware systems; and
updating one or more parameters of a machine learning model based on the plurality of statistics and the plurality of sets of attributes, wherein the priority score is computed by the updated machine learning model based at least on input that includes the corresponding set of attributes.

14. The processor of claim 11, wherein the determining the one or more map data units to be evicted comprises:
determining, based at least on a subset of the plurality of priority scores for a plurality of map tiles included in the plurality of map data units, a priority score indicating a lowest cost associated with evicting a corresponding map tile included in the plurality of map tiles; and
determining, based at least on a plurality of layers included in the corresponding map tile, a layer to be evicted from the memory.

15. The processor of claim 14, wherein the layer to be evicted from the memory is determined based at least on a second subset of the plurality of priority scores for the plurality of layers.

16. The processor of claim 15, wherein the set of attributes corresponding to each of the plurality of layers comprises at least one of a layer size, a layer importance, a number of requests associated with a layer, a staleness of a layer, or a download time associated with a layer.

17. The processor of claim 14, wherein the set of attributes corresponding to each of the plurality of map tiles comprises at least one of a last time of use, a frequency of use, a geographic distance from a current location of the location-aware system, an overlap with a route associated with a vehicle, a map tile size, a time of day, or a day of the week.

18. The processor of claim 11, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. A system comprising:
one or more processing units to perform operations comprising:
determining a corresponding set of attributes for each of a plurality of map data units stored in a memory within a location-aware system;
for each map data unit included in the plurality of map data units, computing a priority score for the map data unit based on the set of attributes corresponding to the map data unit;
determining, based on the plurality of priority scores for the plurality of map data units, one or more map data units to be evicted from the memory; and
causing at least a portion of the one or more map data units to be at least one of deleted from or replaced in the memory in response to receiving one or more new map data units for storage in the memory.

20. The system of claim 19, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
